(19) United States
(12) Patent Application Publication
(10) Pub. No.: US 2004/0245355 A1
(43) Pub. Date: Dec. 9, 2004

(54) Mixer and sprayer unit

(75) Inventors: Mark A. Fettig, Prior Lake, MN (US); Lisa S. Fettig, Prior Lake, MN (US)

Correspondence Address: E. J. Brooks & Associates, PLLC, Suite 500, 1221 Nicollet Avenue, Minneapolis, MN, 55403, US

(73) Assignee: Fettig Drywall

(21) Appl. No.: 10/456,709

(22) Filed: Jun. 6, 2003

(51) Int. Cl. B05B 9/03; A62C 13/62; A62C 13/66; A62C 35/58

(52) U.S. Cl. 239/302

(57) ABSTRACT

Systems, methods and devices for a mixer and sprayer unit are provided. A mixer and sprayer unit includes a mixing container for combining mixture ingredients, a nozzle operable to spray the mixture ingredients, and base unit containing a pump component. The pump component is operable to convey the mixture ingredients from the mixing container to the nozzle. The base unit and the mixing container are a unitary structure. A transport mechanism is coupled to the base unit and operable to facilitate portability of the mixer and sprayer unit.

Devices and systems for spraying substances onto surfaces have been utilized in many fields. For example, finishes or textured coatings applied to surfaces of walls or ceilings of buildings are typically comprised of one or more ingredients combined into a mixture. The ingredients can include liquids, powders, and solids, among others. The mixture is usually projected onto the surfaces by using a spraying device. One common type of portable spraying device has a conical-shaped hopper to hold a quantity of a mixture to be used in the spraying process. In this type of spraying device the mixture in the hopper is gravity fed to a pumping mechanism. The pumping mechanism conveys the mixture through a hose to a spray nozzle.

In a typical spraying system, ingredients are placed in a separate mixing container and combined to form a mixture. The mixing process generally takes place at or near the job site. The mixture must be transferred from the separate mixing container to the hopper of the spraying device. The hopper on a typical portable sprayer can contain about 5 to 15 gallons of mixture, thus requiring frequent refilling. The transfer of the mixture creates a time-consuming step and can be messy, due to spillage. It is not feasible to mix the ingredients in the hopper, due to the hopper's conical shape and its proximity to the pumping mechanism. In addition, cleanup of such systems can be difficult and time-consuming.

Spraying systems of sufficient size to dispense large amounts of mixture are commonly available. These systems typically hold over 40 gallons of mixture and are usually transported to and from the job site on trailers. However, these larger systems tend to be cumbersome. Many such systems are too bulky, to bring into a building or other structure where spraying is to be performed, and must be parked outside. If such a system is left out doors at a work site, the system often must be sheltered from adverse weather conditions. For example, water-based mixtures are susceptible to solidification at subfreezing temperatures. In cold weather, the system and its contents must be insulated or heated to prevent freezing. In addition, workers inside a structure must often leave the inside work site to refill and maintain the spraying apparatus.

Other devices and systems have been developed especially for mixing substances. As an example, ingredients can be placed in a mixing container. In some devices, the mixing container can utilize a motor which drives a mixing device to mix the ingredients. The ingredients are typically mixed together to form a viscous substance, such as a drywall joint compound. In some instances, the motor also powers a pumping mechanism to dispense the viscous substance to a receptacle. In certain settings, the receptacle can include drywall taping tools, fill pans, buckets, trowels, among others. This type of system eliminates the need for transferring the mixture from a separate mixing container by hand. However, this type of system is unsuitable for delivering fluid mixtures to a spray nozzle for spraying coatings onto surfaces, due to its low pumping volume and low pressure methods of delivery.

### BRIEF DESCRIPTION OF THE DRAWINGS

FIG. 1 illustrates a perspective view of an example of a prior art sprayer unit.

FIG. 2 illustrates a perspective view of another example of a prior art sprayer unit.

FIG. 3 illustrates a perspective view embodiment of a mixer and sprayer unit.

FIG. 4 illustrates a cutaway view embodiment of a mixer and sprayer unit.

FIG. 5 illustrates a cutaway view embodiment of another mixer and sprayer unit.

FIG. 6 illustrates a perspective view embodiment for cleaning a mixer and sprayer unit.

FIG. 7 illustrates a perspective view from above of an embodiment for storage and transport of a mixer and sprayer unit.

FIG. 8 illustrates an exploded perspective view embodiment of a mixer and sprayer unit.

### DETAILED DESCRIPTION

The present invention provides a mixer and sprayer unit. The present invention includes various embodiments that can provide for mixing of ingredients in a container, and delivery of the ingredients to a spray nozzle. In various embodiments, the invention can provide within a single, self-contained unit the mixing, pressurization, and delivery of the ingredients to the spray nozzle.

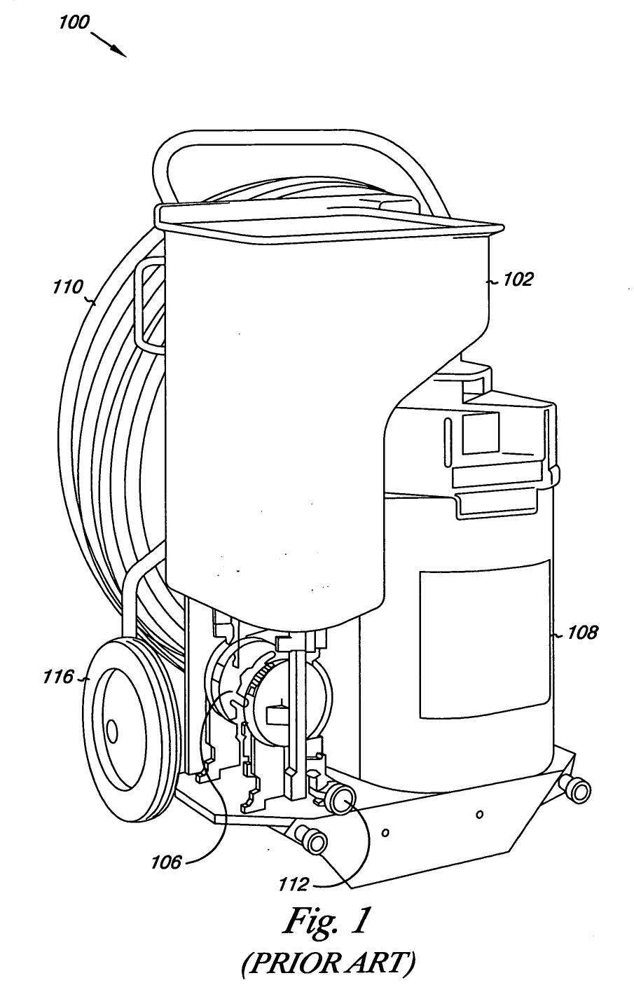

FIG. 1 illustrates a perspective view of an example of a prior art sprayer 100. Such sprayers are commonly used to spray mixtures such as paint, finishes, ceiling texture, firestop coatings, or others, onto surfaces. As shown in FIG. 1, the sprayer 100 includes a hopper 102, a pump motor 106, and a delivery and/or air hose 110. The sprayer 100 includes a transport mechanism 116, such as a dolly, to provide some portability. Ingredients are typically mixed together in a separate mixing container (not shown), such as a tub, vat, or bucket, among others. Once the ingredients are formed into a mixture, a quantity of the mixture can be transferred from the separate mixing container to the hopper 102 of the sprayer 100. The transfer requires some transfer mechanism such as either siphoning, pumping, and/or physical pouring the mixture into the hopper 102. The hose 110 can be connected to the hopper 102 via the pump motor 106 using a nozzle attachment such as nozzle attachment 112. The mixture can then be fed from the hopper 102 to a delivery hose 110 by the pump motor 106. The pump motor 106 can force the mixture through the hose 110 to a spray nozzle (not shown). A separate compressor engine 108 can pressurize air through an air hose 110 which can be attached between the compressor engine and a spray nozzle to spray the mixture from the spray nozzle.

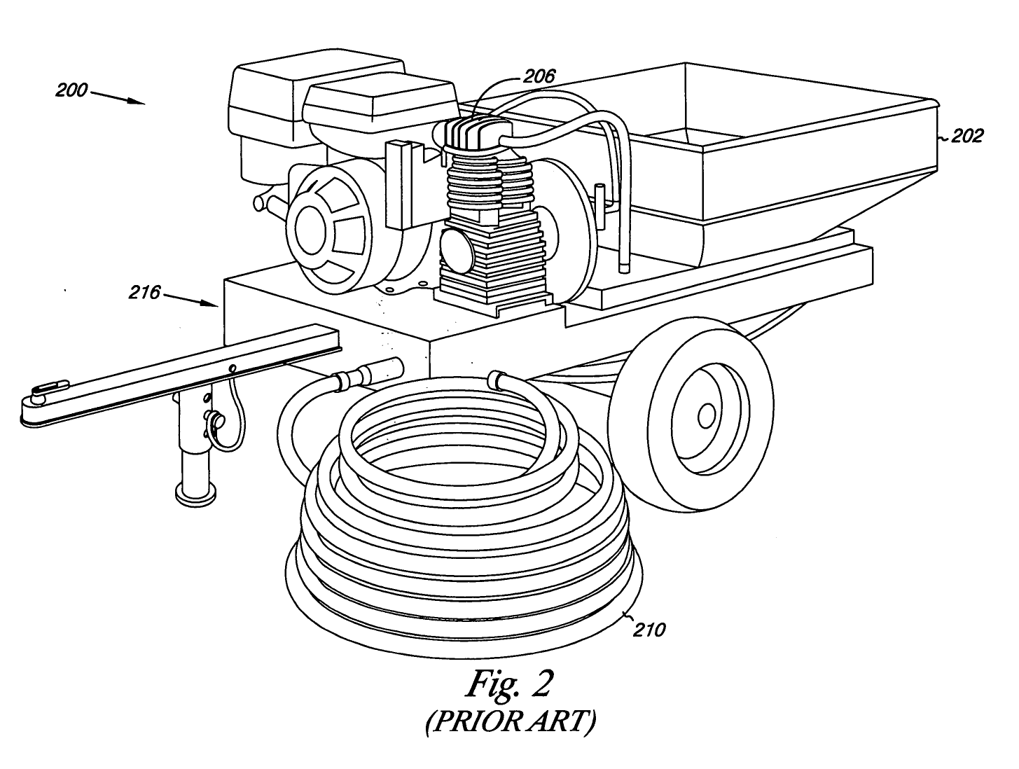

FIG. 2 illustrates a perspective view of another example of a prior art sprayer unit 200. The sprayer unit 200 shown in FIG. 2 represents a large industrial, commercial size spraying apparatus mounted on a trailer 216 which serves as a transport mechanism. The sprayer unit 200 includes a hopper 202, a pump engine and compressor unit 206, and air and delivery hoses 210 attachable thereto. The sprayer unit 200 operates in a similar manner to the prior art sprayer 100 shown in FIG. 1, but provides a larger capacity hopper 202. The sprayer unit 200 is operated in an outside location on a worksite, due to its large size. Ingredients can be mixed in the large industrial size hopper 202 and transferred via the pump engine portion of the pump and compressor unit 206 to the hoses 210. However, the industrial size sprayer unit 200 cannot be transported indoors. Thus, use of the industrial size sprayer unit 200 outdoors is subject to an impact by weather conditions. That is, various mixtures contained in the hopper 202 may need to be maintained within a particular temperature range to provide a correct mixture consistency. Also, with the industrial size sprayer unit 200, a sufficient length of the hose 210 must be provided to deliver the mixture indoors to a spraying location.

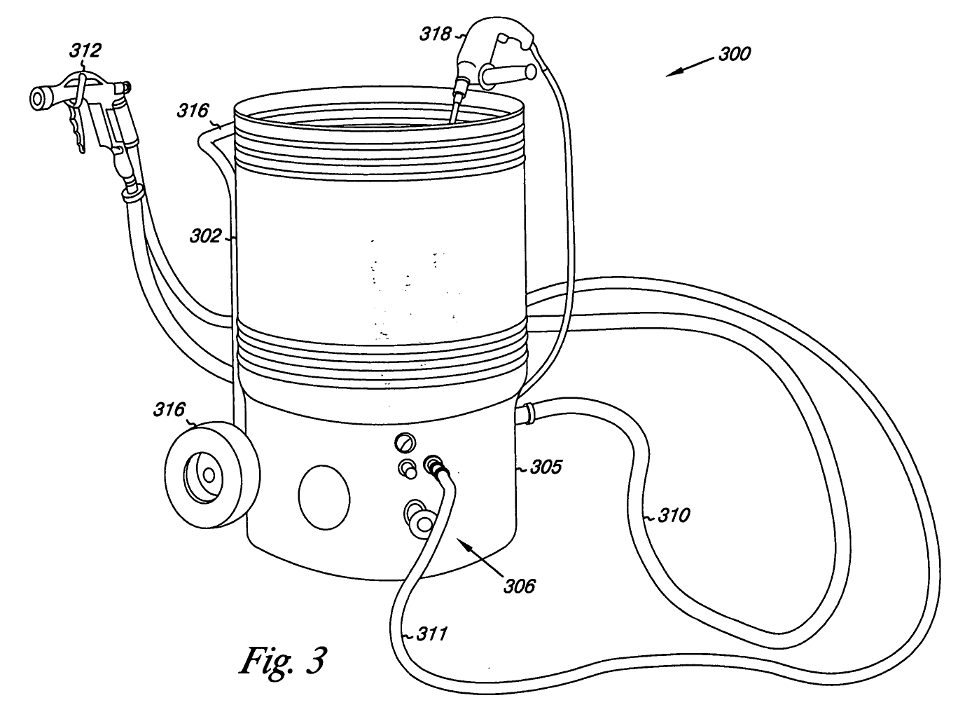

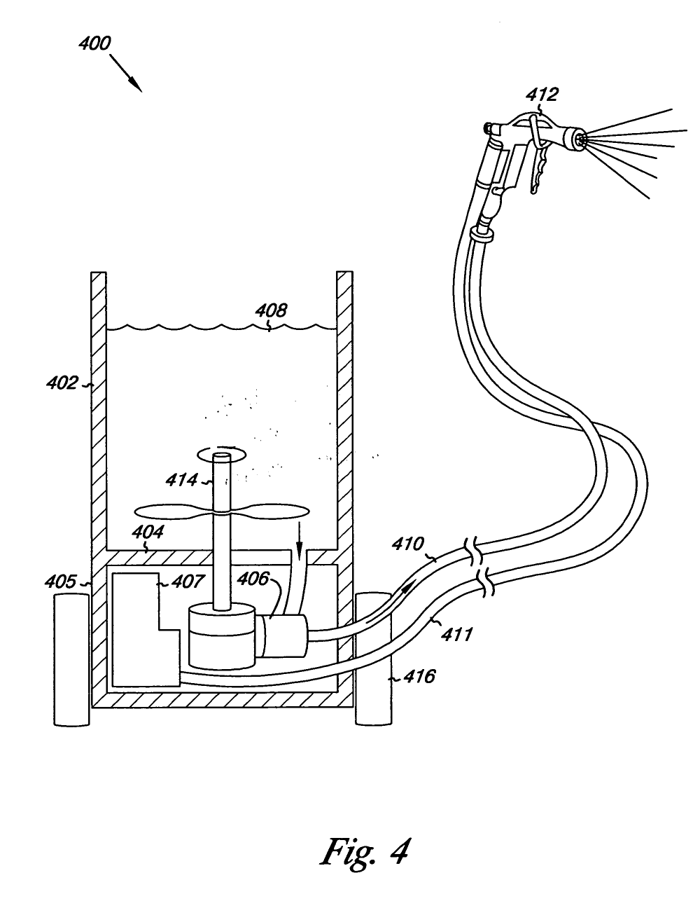

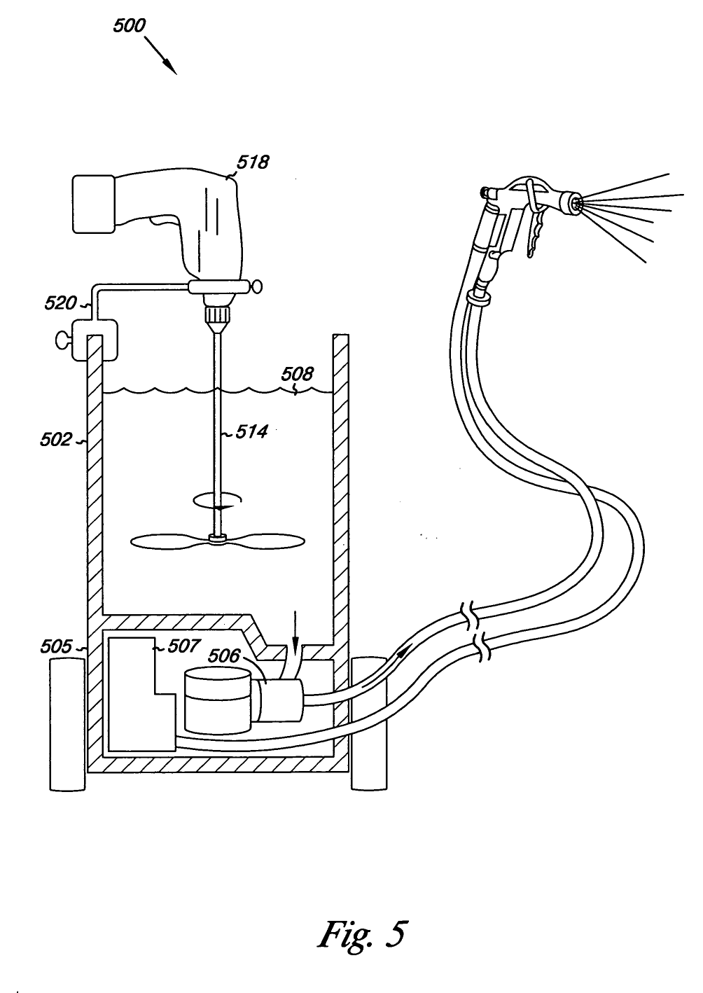

FIG. 3 illustrates a perspective view embodiment of a mixer and sprayer unit 300, according to the teaching of the present invention. The embodiment of FIG. 3 includes a mixing container 302 attached to a base component 305. The base component 305 houses a pump and compressor (shown in the cutaway views of FIGS. 4 and 5) beneath the mixing container 302. As shown in FIG. 3, the mixer and sprayer unit 300 includes a delivery hose 310 attachable to the pump portion within the base component 305 via a nozzle attachment. Likewise, the mixer and sprayer unit 300 includes an air hose 311 attachable to the compressor portion within the base component 305 via a nozzle attachment. The mixer and sprayer unit 300 also includes a transport mechanism 316 which can include wheels and a handle. The transport mechanism 316 thus allows the mixer and sprayer unit 300 to be transported through halls and standard size doorways of buildings as a single unit. That is, as shown in the embodiment of FIG. 3, the mixing container 302 and the base component 305 are configured as a single, self-contained unit. In some embodiments, the mixing container 302 can be detachable from the base component 305 for accessibility to the pump and compressor with the base component 305. In some embodiments, a bottom of the base component 305 is open ended such that when not in use the sprayer and mixer unit can be reversed on end to access the pump and compressor component.

Ingredients can be mixed together in the mixing container 302 to form a mixture. In various embodiments, the mixing container 302 has a flat bottom, as shown in FIG. 4, which facilitates even mixing of the ingredients. In other embodiments, the bottom of the mixing container 302 can be concave, pan-shaped, or it can have a recess to facilitate channeling the mixture to the pump component, such as shown in FIG. 5. The mixing container 302 can hold 30 or more gallons of ingredients thus enabling a large batch of a mixture to be prepared directly on the mixer and sprayer unit 300 above the pump and compressor in the base component 305.

As one of ordinary skill in the art will appreciate, this obviates the need for a separate mixing container, such as a tub, vat, yard trash can, or bucket as required for the spraying device described in connection with FIG. 1 since the hoppers associated with such previously existing sprayer devices are not suitable for mixing ingredients directly on the sprayer device or holding a comparable size batch of mixture. Additionally, the mixer and sprayer unit 300 of the present invention obviates the need to repeatedly, physically transfer a mixture from a separate mixing container, whether by siphon, pump, and/or physical pouring, to the limited size hoppers provided on conventional indoor spraying devices such as illustrated in FIG. 1.

As one of ordinary skill in the art will appreciate, the mixer and sprayer unit 300 of the present invention can increase productivity since the large capacity of the mixing container 302 enables a user to perform a spraying job, such as spraying interior ceilings of a residential home or an office building, without refilling the mixing container 302. The mixer and sprayer unit 300 of the present invention can also increase productivity by virtue of the fact that transport, set-up, and clean-up time of the unit 300 are significantly reduced, as discussed in more detail below.

In various embodiments, the ingredients to be mixed in the mixing container 302 can include water-based or petroleum-based substances, such as paints, finishes, and texture coatings. Other ingredients can include firestop materials, acoustic coatings, splatter coats, and sealants, among others.

The pump device within the base component 305 is operable to draw the mixture from the mixing container 302. By virtue of the mixer and sprayer unit's 300 configuration, gravity will assist in feeding the mixture to the pump device 306. The pump device is operable to force the mixture through the delivery hose 310 to a spray nozzle 312. As noted above, the base component 305 also includes a compressor, as shown in FIG. 4 that generates compressed air to be delivered through an air hose 311 to atomize the mixture at the spray nozzle 312 and enable the mixture to be sprayed on a surface such as, for example, a ceiling and/or wall.

In various embodiments, the mixer and sprayer unit 300 includes an attachment, or mounting arm, (as shown in FIG. 5) suited to mount a motorized tool 318, such as a drill, to the mixing container 302. As one of ordinary skill in the art will appreciate, a motorized tool such as a drill can be provided with a mixing bit in order to facilitate mixing ingredients within the mixing container 302. However, the invention is not so limited. That is, the motorized tool 318 can include any motorized tool, whether battery powered or otherwise, which is operable to agitate ingredients in the mixing container 302 as part of a mixing process. Such a motorized tool 318 can be provided to independently mix the ingredients in the mixing container 302, or the motorized tool 318 can be compliment an internal mixing device, as shown in FIGS. 4 and 5.

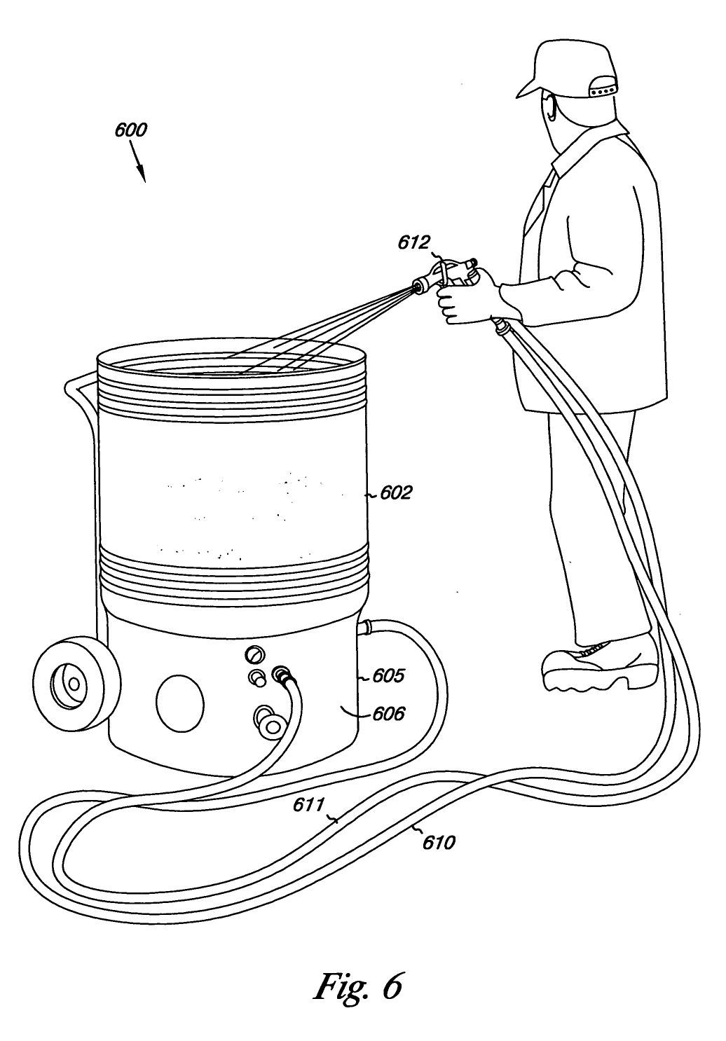

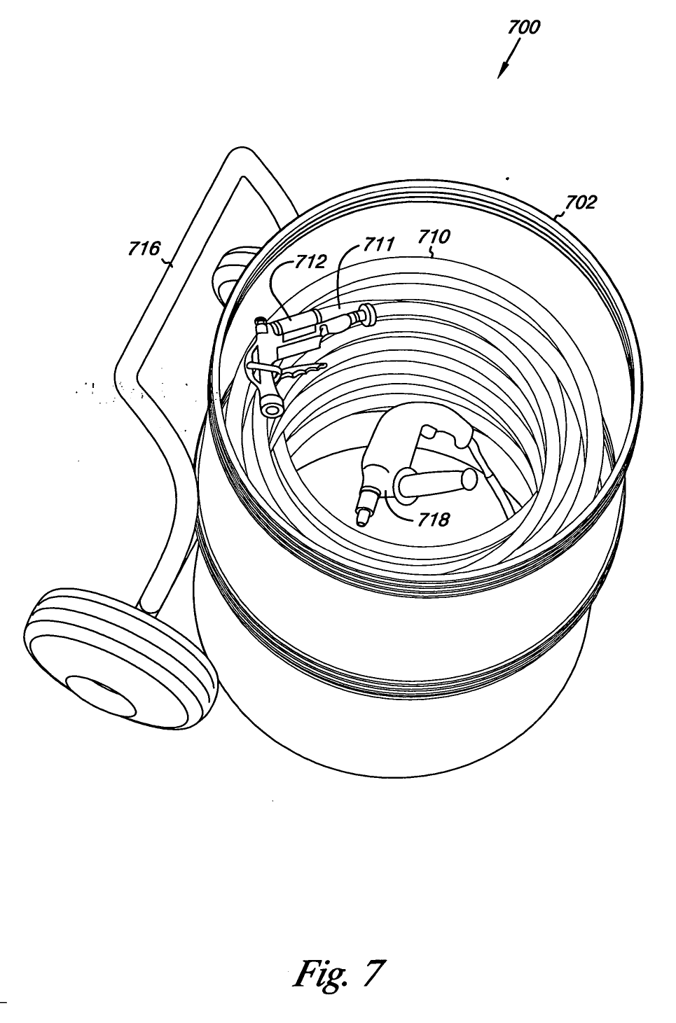

As will be discussed in more detail with the embodiments shown in FIGS. 6 and 7, the delivery hose 310 and air hose 311 can be placed inside the mixing container 302 to facilitate easy transport to and from a worksite. For example, after use the delivery hose 310 and the air hose 311 can be stored inside the mixing container 302. The transport mechanism 316 provides portability to the mixer and sprayer unit 300. In various embodiments, the mixer and sprayer unit 300, and associated components can be transported by one person into buildings and through standard doorways.

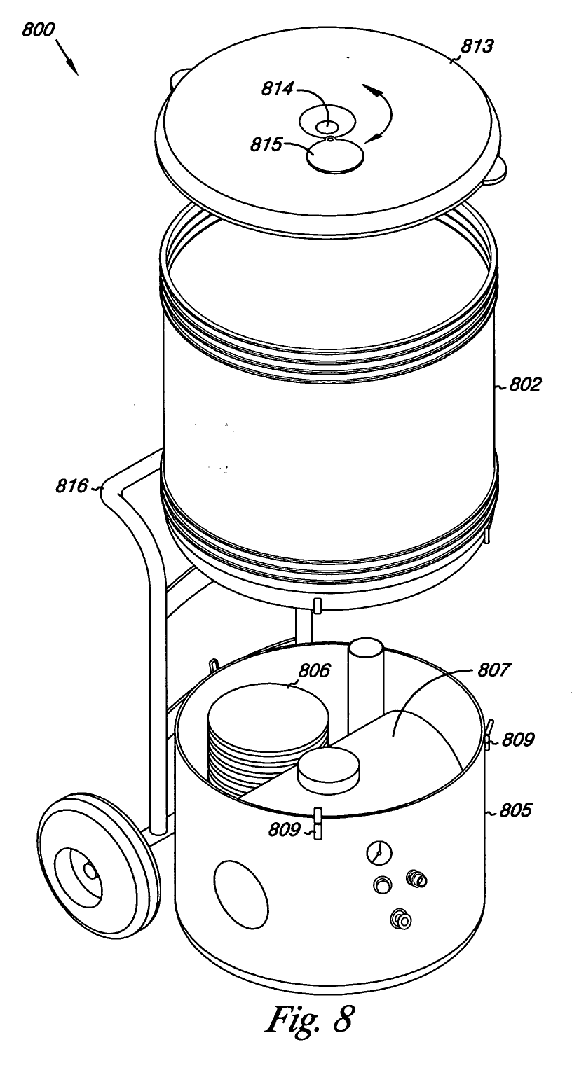

FIG. 4 illustrates a cutaway view embodiment of a mixer and sprayer unit 400, according to the teaching of the present invention. The embodiment of FIG. 4 includes a mixing container 402. In various embodiments, the mixing container 402 is a drum that is cylindrical in shape. The mixing container 402 has a bottom surface 404 that is flat, which better facilitates the mixing of the ingredients than typical conical-shaped containers. In various embodiments, the mixing container 402 can take the form of other shapes, such as rectangular, elliptical, among others. In other embodiments, the bottom surface 404 can be formed into other shapes, such as concave, and/or pan-shaped, among others, to facilitate delivery of the mixture to base component 405. In various embodiments the mixing container 402 can be sealed with a cover, as shown in FIG. 8, allowing the contents of the mixing container 402 to be pressurized and/or stored. In these embodiments, the cover is operable to reduce contamination within the mixing container 402. The mixing container 402 can be constructed from metal, plastic, composite materials, ceramics, or combinations thereof, among others.

The embodiment of FIG. 4 includes a pump device 406 that is located in the base component 405. The pump device 406 can be powered by an electric motor or a gas engine. The pump device 406 is operable to convey the mixture ingredients 408 from the mixing container 402, through a hose 410 to a spray nozzle 412. The embodiment of FIG. 4 includes a compressor 407, which is located in the base component 405. The compressor 407 is operable to generate compressed air that is delivered through an air hose 411 to the spray nozzle 412. The compressed air atomizes the mixture ingredients 408 into a spray pattern at the spray nozzle 412 in order to spray a surface.

In some embodiments, the pump device 406 is operable to drive a mixing device 414. The mixing device 414 can include one or more shafts, rods, or blades, among others. In various embodiments, the mixing device 414 can be operable to mix the mixture ingredients 408 during spraying. The mixing device 414 can also be operable to stir the mixture ingredients 408 when spraying is not occurring, to maintain the integrity of the mixture ingredients 408. The mixing device 414 can be connected directly to the pump device 406. The mixing device 414 can also be connected to the pump device 406 using one or more pulleys, gears, or servo mechanisms, among others. In other embodiments, a separate motor (not shown) can be used to drive the mixing device 414. In these embodiments, the separate motor can be electric, gas, or air powered, among others.

In various embodiments, the mixing container 402 and the base component 405 are a unitary device as shown in FIG. 4. In other embodiments, the mixing container 402 can be removed from the base component 405 as shown in FIG. 8. The mixer and sprayer unit 400 can have a transport mechanism 416 to provide portability. The transport mechanism 416 can include one or more wheels, rollers, or casters, among others. In various embodiments, the mixer and sprayer unit 400 can be transported through doorways by one person.

FIG. 5 illustrates a cutaway view embodiment of another mixer and sprayer unit 500, according to the teaching of the present invention. The embodiment of FIG. 5 includes a mixing container 502, and a base component 505 containing a pump device 506 and an air compressor 507. As shown in the embodiment of FIG. 5, a motorized tool 518, such as a drill, can be attached to the mixing container 502 to drive a mixing device 514. The motorized tool 518 and the mixing device 514 allow mixture ingredients 508 to be mixed while the mixer and sprayer unit 500 is in use. In other embodiments, the motorized tool 518 and the mixing device 514 can be adapted to assist internal mixing devices, such as those shown in FIG. 4, among others. The motorized tool 518 can be clamped or attached to the mixing container 502 using a mounting device 520. The mounting device 520 can be adjustable to position the motorized tool 518 in different locations and angles.

FIG. 6 illustrates a perspective view embodiment for cleaning a mixer and sprayer unit 600, according to the teaching of the present invention. The embodiment shown in FIG. 6 includes a mixing container 602 and a base component 605 containing a pump component and an air compressor component therein 606 in a unitary structure. Embodiments of the invention afford a more streamlined cleanup of the mixer and sprayer unit 600 than required in previous devices. Cleaning fluid, such as water, detergent, or solvent, or others, can be placed inside the mixing container 602. The cleaning fluid is conveyed by the pump component 606 within the base unit 605 through a hose 610 to a spray nozzle 612. The cleaning fluid can be operable to purge remaining mixing ingredients from within the hose 610 by flushing the mixing ingredients from the hose 610 and ejecting it through the spray nozzle 612. The air compressor 606 inside the base component 605 provides compressed air that is passed through an air hose 611 to the spray nozzle 612. The cleaning fluid can also clean the spray nozzle 612 by purging remaining mixture ingredients from the spray nozzle 612. Additionally, the mixing container 602 can be cleaned by spraying cleaning fluid through the spray nozzle 612 into the mixing container 602. FIG. 6 illustrates a user directing the cleaning fluid from the spray nozzle 612 back into the mixing container 602, thus confining the purged material to the mixer and sprayer unit 600 and reducing contamination of surrounding work areas. In this manner, the cleaning fluid can be cycled in a loop through the mixer and sprayer unit 600. Once sufficient cycling has occurred to purge the mixer and sprayer unit, the spray nozzle 612 can be directed into a waste container or other depository to cycle the cleaning fluid out of the mixer and sprayer unit 600. In other embodiments, various components, such as the hose 610, the air hose 611, and the spray nozzle 612, among others, can be placed in the mixing container 602 to be cleaned. Other objects can be placed within the mixing container 602 for cleaning.

FIG. 7 illustrates a perspective view from above an embodiment for storage and transport of a mixer and sprayer unit 700, according to the teaching of the present invention. As mentioned earlier, embodiments of the invention facilitate easy, one-trip transport, to and from a work location, of the tools associated with a spraying job, e.g. spraying a mixture on a surface. As used herein, primary tools include, but are not limited to, spray nozzles, hoses, and hand tools, among others. As used herein, one-trip transport is intended to mean that a user is not required to make multiple trips to bring the various primary tools to a work area from a vehicle or other location. The embodiment shown in FIG. 7 includes a mixing container 702 within which other components, or tools, of the mixer and sprayer unit 700 can be stored and transported. For example, as shown in the embodiment, the flat bottom of the mixing container 702 allows a delivery hose 710 and an air hose 711 to be coiled and placed inside when not in use. Other tools or components can be stored within the mixing container 702, such as a spray nozzle 712, a motorized tool 718, among others. As noted above, the mixer and sprayer unit 700 include a transport mechanism 716 to provide portability. The transport mechanism 716 can include one or more wheels, rollers, handles, and/or casters, among others. In this manner, once the tools and components associated with a spraying job have been stored in the mixer and sprayer unit 700, the unit can be can be transported through doorways into and out of a work area in a single trip by one person.

FIG. 8 illustrates an exploded perspective view embodiment of a mixer and sprayer unit 800, according to the teaching of the present invention. The embodiment shown in FIG. 8 illustrates a mixing container 802 detached from a base component 805. The base component 805 contains a pump device 806 and a compressor 807. In various embodiments, the mixing container 802 can be removably attached to the base component 805. The mixing container 802 can be attached to the base component 805 by one or more latches 809. In other embodiments, the mixing container 802 can also be attached to the base component 805 by one or more pins, threaded fittings, screws, or clamps, among others. In various embodiments, the mixing container 802 can be removed from the base component 805 to allow access to the pump device 806 or other components. The mixing container 802 can be removed for cleaning or servicing.

As shown in the embodiment of FIG. 8, the mixing container can be provided with a removable cover, or lid, 813 which is operable to enclose and/or to protect the contents of the mixing container 802 from contamination or otherwise. In some embodiments, the removable cover 813 can have an aperture 814 to allow insertion of a mixing device through the removable cover 813 into the mixing container 802. In various embodiments, the aperture or opening 814 can be configured to seat and/or nest a motorized mixing tool on the cover 813. The aperture 814 in the removable cover 813 can also include another cover mechanism 815 to cover the aperture when not in use.

As one of ordinary skill in the art will appreciate, the removable cover 813 can aid in maintaining the quality of mixing ingredients that contained, stored, or held within the mixing container 802 for extended periods of time. In other words, the removable cover 813 can minimize evaporation or drying of the mixing ingredients inside the mixing container 802. In some embodiments, the removable cover 813 can be attached to the mixing container 802 in order to provide the ability to seal and pressurize the contents of the mixing container 802.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the invention. It is to be understood that the above description has been made in an illustrative fashion, and not a restrictive one. Combination of the above embodiments, and other embodiments not specifically described herein will be apparent to those of skill in the art upon reviewing the above description. The scope of the various embodiments of the invention includes any other applications in which the above structures and methods are used. Therefore, the scope of various embodiments of the invention should be determined with reference to the appended claims, along with the full range of equivalents to which such claims are entitled.

It is emphasized that the Abstract is provided to comply with 37 C.F.R. § 1.72(b) requiring an Abstract that will allow the reader to quickly ascertain the nature of the technical disclosure. It is submitted with the understanding that it will not be used to limit the scope of the claims.

In the foregoing Detailed Description, various features are grouped together in a single embodiment for the purpose of streamlining the disclosure. This method of disclosure is not to be interpreted as reflecting an intention that the embodiments of the invention require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1. A mixing device, comprising:
a mixing unit for combining mixture ingredients;
a nozzle operable to spray the mixture ingredients;
a compressor operable to atomize the mixture ingredients at the nozzle; a base unit containing the compressor and a pump component, the pump component operable to convey the mixture ingredients from the mixing unit to the nozzle, wherein the base unit and the mixing unit are a unitary structure, and wherein the unitary structure includes the mixing unit resting above the base unit in a vertically stacked configuration having a width of less than four feet; and
a transport mechanism coupled to the base unit and operable to facilitate portability of the mixing device.

2. (Canceled)

3. The mixing device of claim 1, wherein the pump component is operable to feed the mixture ingredients to the nozzle by employing a vacuum pump.

4. (Canceled)

5. The mixing device of claim 1, wherein the pump component conveys the mixture ingredients to the nozzle using a hose.

6. A mixing device, comprising:
a container to contain a quantity of mixture ingredients, the container having a bottom surface to facilitate combining the mixture ingredients;
a base component attached to the container as a single unit, the base component containing a pump and a compressor, wherein the single unit includes the container resting above the base component in a vertically stacked configuration having a width of less than four feet; and
an aperture fabricated into the bottom surface of the container configured to allow the one or more mixture ingredients to be conveyed to the pump.

7. The mixing device of claim 6, wherein the device further includes a removable cover, and wherein the mixture ingredients can be mixed while pressurized.

8. The mixing device of claim 6, wherein the bottom surface is flat.

9. The mixing device of claim 6, wherein the container includes a mounting device to mount a motorized tool.

10. The mixing device of claim 9, wherein the motorized tool includes a drill.

11. The mixing device of claim 6, wherein the container has a volume of 30 or more gallons.

12. The mixing device of claim 6, wherein the container is removably attached to the base component.

13. A mixer and sprayer unit, comprising:
a mixing container located above and coupled to a base component, the base component housing a pump and a compressor, wherein the mixing container coupled to the base component includes a vertically stacked configuration having a width of less than four feet;
the pump and the compressor coupled to a spray nozzle; and
means for mixing ingredients within the mixing container.

14. The mixer and sprayer unit of claim 13, wherein the means for mixing ingredients includes a mixing device powered by the pump.

15. The mixer and sprayer unit of claim 13, wherein the means for mixing ingredients includes a mounting device operable to mount a motorized tool to the mixing container, the motorized tool operable to drive a mixing device.

16. A mixer and sprayer unit, comprising:
a base component having a motorized pump and a compressor operable to deliver ingredients and air pressure through hoses to a spray nozzle;
a transport mechanism attached to and operable to provide portability to the mixer and sprayer unit; and
a container operable to mix ingredients and integrated with the base component, the container suitable for storing the hoses and the spray nozzle when not in use, wherein the container rests above the base component in a vertically stacked configuration having a width of less than four feet.

17. A method for spraying surfaces, comprising:
providing mixture ingredients to a mixing container located above and coupled to a base unit, the base unit including a pump and a compressor, wherein the mixing container coupled to the base unit includes a vertically stacked configuration having a width of less than four feet;
mixing the mixture ingredients in the mixing container; and
conveying the mixture ingredients to a spray nozzle coupled to the pump and the compressor.

18. The method of claim 17, wherein mixing the mixture ingredients includes using a motorized tool removably attachable to the mixing container.

19. The method of claim 18, wherein using a motorized tool includes using a powered drill with a mixing bit.

20. A method of cleaning a mixer and sprayer unit, comprising:
providing a cleaning fluid to a mixing container, the mixing container located above and coupled to a base unit, the base unit including a pump and a compressor, wherein the mixing container coupled to the base unit includes a vertically stacked configuration having a width of less than four feet;
pumping the cleaning fluid through a hose to a spray nozzle; and
purging the hose and the spray nozzle with the cleaning fluid by spraying the cleaning fluid into the mixing container.
